(19) United States
(12) Patent Application Publication
(10) Pub. No.: US 2007/0108714 A1
(43) Pub. Date: May 17, 2007

(54) Rear suspension system

(76) Inventors: Sang Dae Kim, Suwon-city (KR); Kwang Ho Lee, Goyang-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/299,373

(22) Filed: Dec. 8, 2005

(30) Foreign Application Priority Data
Nov. 11, 2005 (KR) 10-2005-0108115

(51) Int. Cl. B60G 9/00; B60G 21/05

(52) U.S. Cl. 280/124.116; 280/124.128

(57) ABSTRACT

A rear suspension system includes a plurality of trailing arms, a beam defining a space therein, and a plurality of reinforcing members, each with a first end connected to a respective one of the trailing arms and a second end contacting an interior surface of the beam. The second end of each reinforcing member is branched into two portions with a rod disposed between them. Each reinforcing member has at least one and preferably two curved portions, one near each end, both curved along the beam axis such that the second end of the reinforcing member is parallel with the rod.

### CROSS-REFERENCE TO RELATED APPLICATION

This application claims priority to and the benefit of Korean Patent Application No. 10-2005-0108115 filed in the Korean Intellectual Property Office on Nov. 11, 2005, the entire contents of which are incorporated herein by reference.

### BACKGROUND OF THE INVENTION

(a) Field of the Invention

The present invention relates to a rear suspension system of a vehicle. More particularly, the present invention relates to a rear coupled torsion beam axle (CTBA) suspension system having enhanced durability.

(b) Description of the Related Art

Generally, a suspension system of a vehicle absorbs shocks transmitted from the road and controls vehicle body dynamics during acceleration, deceleration, and cornering.

A conventional rear suspension system includes a plurality of trailing arms, a rod, a beam, and a plurality of reinforcing members. The rod and the beam connect the trailing arms to each other, and the reinforcing members connect each trailing arm to the beam.

Portions of the beam and the reinforcing members where the two connect are particularly prone to being cracked or broken by shocks from the road or vibrations of the vehicle body.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a rear suspension system with enhanced durability.

A rear suspension system according to an exemplary embodiment of the present invention includes: a plurality of trailing arms, each connected to a rear wheel; a beam connecting the trailing arms to each other and defining a space therein; and a plurality of reinforcing members, each with one end connected to one of the trailing arms and the other end contacting an interior surface of the beam, and comprising at least one curved portion, curved along the beam axis.

In one embodiment, there are two curved portions: one near the end connected to the trailing arm, and the other near the end contacting the interior surface of the beam.

### BRIEF DESCRIPTION OF THE DRAWINGS

FIG. 1 is a perspective view of a rear suspension system according to an exemplary embodiment of the present invention.

FIG. 2 is a side elevational view of a rear suspension system according to an exemplary embodiment of the present invention.

FIG. 3 is a drawing showing a reinforcing member of a rear suspension system according to an exemplary embodiment of the present invention.

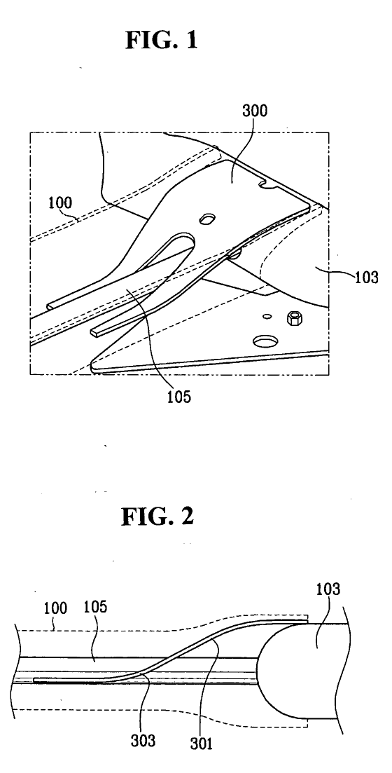

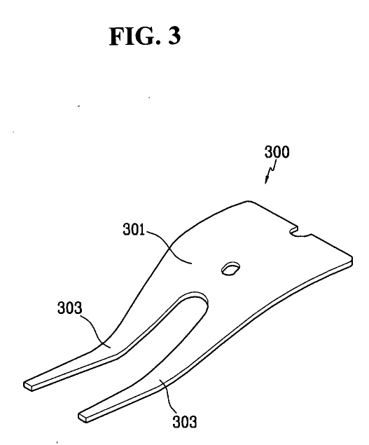

### DETAILED DESCRIPTION OF THE PREFERRED EMBODIMENTS

An exemplary embodiment of the present invention will hereinafter be described in detail with reference to the accompanying drawings.

A rear suspension system according to an exemplary embodiment of the present invention includes a plurality of trailing arms 103, a beam, 100, and a plurality of reinforcing members 300.

The trailing arms 103 are each connected to a rear wheel (not shown), the beam 100 connects the trailing beams 103 to each other, and the beam 100 defines a space therein.

One end of the reinforcing member 300 is attached to the trailing arm 103, and the other end contacts an interior surface of the beam 100. The reinforcing member 300 includes at least one curved portion 301, 303.

A rod 105 connecting the trailing arms to each other may be disposed in the space defined within the beam 100. In one embodiment, the rod 105 has a cross-section in the shape of a V.

In addition, the end of the reinforcing member 300 that contacts the beam 100 is divided into two branches, and the rod 105 is disposed between the two branches. The branches narrow toward this end such that the V-shaped rod 105 can be inserted between the two branches.

The curved portions are curved along the axis of the beam 100. In one embodiment, there are two curved portions: a first curved portion 301 and a second curved portion 303.

The first curved portion 301 is formed near the end attached to the trailing arm 103, and the second curved portion 303 is formed near the other end, which contacts the interior surface of the beam 100.

The first curved portion 301 is curved toward the other end, and the second curved portion 303 is curved such that the end thereof is parallel with the rod 105.

As described above, since the reinforcing member 300 includes two curved portions 301 and 303, durability of the reinforcing member 300 and the beam 100 are enhanced.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A rear suspension system, comprising:
a plurality of trailing arms, each connected to a rear wheel;
a beam connecting the trailing arms to each other and defining a space therein; and
a plurality of reinforcing members, each comprising:
a first end connected to a respective one of the trailing arms;
a second end contacting an interior surface of the beam; and
at least one curved portion.

2. The rear suspension system of claim 1, wherein the at least one curved portion is curved along an axis of the beam.

3. The rear suspension system of claim 1, wherein the at least one curved portion comprises exactly two curved portions.

4. The rear suspension system of claim 3, wherein the exactly two curved portions comprise:
a first curved portion formed near said first end of said reinforcing member; and
a second curved portion formed near said second end of said reinforcing member.
